(19) United States
(12) Patent Application Publication
(10) Pub. No.: US 2013/0107250 A1
(43) Pub. Date: May 2, 2013

(54) FREE-STANDING STRUCTURES FOR MOLECULAR ANALYSIS

(71) Applicants: Wei Wu, Palo Alto, CA (US); Zhiyong Li, Foster City, CA (US); Ansoon Kim, Mountain View, CA (US); Min Hu, Sunnyvale, CA (US); Michael Josef Stuke, Palo Alto, CA (US)

(72) Inventors: Wei Wu, Palo Alto, CA (US); Zhiyong Li, Foster City, CA (US); Ansoon Kim, Mountain View, CA (US); Min Hu, Sunnyvale, CA (US); Michael Josef Stuke, Palo Alto, CA (US)

(21) Appl. No.: 13/282,606

(22) Filed: Oct. 27, 2011

(51) Int. Cl. G01N 21/01

(52) U.S. Cl. 356/244

(57) ABSTRACT

A structure for molecular analysis is disclosed. The structure includes a nanostructure and a nanoparticle attached to the nanostructure, wherein the nanostructure is free-standing and wherein the nanoparticle, the nanostructure or both the nanoparticle and the nanostructure are coated with a metal coating; or a plurality of nanoparticles, wherein the plurality of nanoparticles is free-standing and wherein each nanoparticle in the plurality is coated with a metal coating and is separated from one other nanoparticle or two other nanoparticles by a distance of 0.5 nm to 1 nm. A method for preparing the structure for molecular analysis is also disclosed.

### STATEMENT OF GOVERNMENT INTEREST

This invention was made with government support under Contract No. HR0011-09-3-0002, awarded by Defense Advanced Research Projects Agency. The government has certain rights in the invention.

### BACKGROUND

Examples of the present invention relate generally to systems for performing molecular analysis, such as surface-enhanced Raman spectroscopy (SERS), enhanced fluorescence, enhanced luminescence, and plasmonic sensing, among other systems.

With specific regard to SERS, Raman spectroscopy is a spectroscopic technique used in condensed matter physics and chemistry to study vibrational, rotational, and other low-frequency modes in molecular systems. In a Raman spectroscopic experiment, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light.” A Raman spectrum may reveal the electronic, vibrational, and rotational energy levels of a molecule. Different molecules produce different Raman spectra that may be used like fingerprints to identify molecules and even to determine the structure of molecules.

Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits, at a frequency that may be lower (i.e., Stokes scattering) or that may be higher (i.e., anti-Stokes scattering) than the excitation photons. The Raman spectrums of different molecules or species (such as virus encapsulations) have characteristic peaks that can be used to identify the species. Accordingly, Raman spectroscopy is a useful technique in a variety of chemical or biological sensing and identification applications. However, the intrinsic Raman scattering process is very inefficient, and as a result, researchers continue to study ways of enhancing the process (i.e., the excitation and/or radiation processes described above).

The Raman scattered light generated by molecules or species adsorbed on or within a few nanometers of a structured metal surface can be 10³ to 10¹⁴ times greater than the Raman scattered light generated by the same species in solution or in a gas phase. This scattering cross section amplification process is called surface-enhanced Raman spectroscopy (“SERS”). In recent years, SERS has emerged as a routine and powerful tool for investigating molecular structures, characterizing interfacial and thin-film systems, and even enabling single-molecule detection. Engineers, physicists, and chemists continue to seek improvements in systems and methods for performing SERS.

### BRIEF DESCRIPTION OF THE DRAWINGS

The detailed description will make reference to the following drawings, in which like reference numerals may correspond to similar, though perhaps not identical, components. For the sake of brevity, reference numerals having a previously described function may or may not be described in connection with other drawings in which they appear.

FIG. 1 is an example structure including metal-coated nanostructures attached to a substrate, wherein each of the metal-coated nanostructures includes one or more nanoparticles.

FIG. 2 is a depiction of example nanostructures including nanoparticles after being released from the substrate in a medium including analytes.

FIG. 3 is a depiction of other example nanostructures attached to a substrate and released from the substrate.

FIGS. 4A-4C, on coordinates of intensity (arbitrary units or a.u.) and wavelength (nanometers or nm), are representative optical scattering spectra depicting the plasmonic resonance from, respectively, an array of nanostructures, an array of nanostructures including analytes, and an array of nanostructures including a target-linked nanoparticle and analytes.

FIGS. 5A-5C, on coordinates of intensity in arbitrary units (a.u.) and Raman shift (centimeters⁻¹ or cm⁻¹), are representative Raman spectra depicting the intensity of signals from, respectively, an array of nanostructures, an array of nanostructures including analytes, and an array of nanostructures including a target-linked nanoparticle and analytes.

### DETAILED DESCRIPTION

Reference is now made in detail to specific examples of the disclosed structure for molecular analysis and specific examples of methods for creating the disclosed structure for molecular analysis. When applicable, alternative examples are also briefly described.

It is noted that, as used in this specification and the appended claims, the singular forms “a,” “an,” and “the” include plural referents unless the context clearly dictates otherwise.

As used in this specification and the appended claims, “about” means a ±10% variance caused by, for example, variations in manufacturing processes.

As used in this specification and the appended claims, “substrate-free” or “free-standing” as it relates to nanostructures means that the nanostructure is not attached to a substrate.

In the following detailed description, reference is made to the drawings accompanying this disclosure, which illustrate specific examples in which this disclosure may be practiced. The components of the examples can be positioned in a number of different orientations and any directional terminology used in relation to the orientation of the components is used for purposes of illustration and is in no way limiting. Directional terminology includes words such as “top,” “bottom,” “front,” “back,” “leading,” “trailing,” etc.

It is to be understood that other examples in which this disclosure may be practiced exist, and structural or logical changes may be made without departing from the scope of the present disclosure. Therefore, the following detailed description is not to be taken in a limiting sense. Instead, the scope of the present disclosure is defined by the appended claims.

Additionally, this discussion has been presented in terms of SERS analysis for the sake of convenience. However, it is noted that the same structure for molecular analysis may be employed in other analytical techniques, including, but not limited to, enhanced fluorescence, enhanced luminescence, plasmonic sensing, optical scattering or optical absorption.

Identifying the optimal, rationally engineered structure for molecular analysis that maximizes detectability in sensing applications by amplifying the intensity of the signals of analytes and other target molecules or by allowing detection of analytes and other target molecules in alternative ways has always been an important goal for researchers in the field of chemical or biological sensing.

Regarding optimizing the design for a structure to be used in molecular analysis, in the past, bottom-up synthesized nanocrystals of various shapes (e.g. wires, cubes, multi-pods, stars, core-shells or bowties) and top-down fabricated structures for molecular analysis (e.g. nanocones, nanograss or grating/antenna hybrid structures) have been extensively studied, wherein “bottom-up” synthesis means growth of nanostructures on a substrate, such as by a vapor-liquid solid method, and “top-down” fabrication refers to lithographical methods of forming nanostructures on a substrate. In the instances discussed above, these structures for molecular analysis may include a substrate on which nanocones, nanograss, nanofingers or other nanostructures may be formed.

SERS structures including a nano-sized structure and at least one analyte or target molecule have also been studied. For these structures to be useful in sensing applications, it is important that the presence of analytes or other target molecules on the structure be easily detectable. Therefore, researchers have studied the use of certain nanoparticles on nanostructures that are capable of enhancing the SERS signals of target molecules or analytes. These nanoparticles may maximize detectability in sensing applications as they may be capable of amplifying the intensity of the Raman signals of analytes and other target molecules or, generally, facilitating detection of analytes and other target molecules.

A new class of structures for sensing applications is disclosed herein, including a free-standing or substrate-free, metal-coated nanostructure including a nanoparticle or a plurality of metal-coated nanoparticles, wherein each nanoparticle in the plurality is separated from one other nanoparticle or two other nanoparticles by a distance of 0.5 nm to 1 nm. As further discussed below, in addition to increasing the SERS signal of target molecules and other analytes, the structures disclosed herein may have a better chance of capturing target molecules and analytes in media as they are free-standing and not attached to a substrate. In other words, they may be capable of moving through media in a less constrained manner to encounter target molecules and analytes, as compared to structures attached to a substrate.

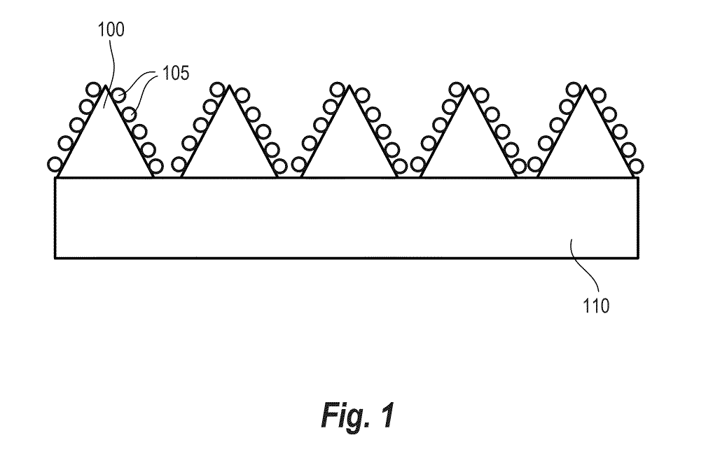

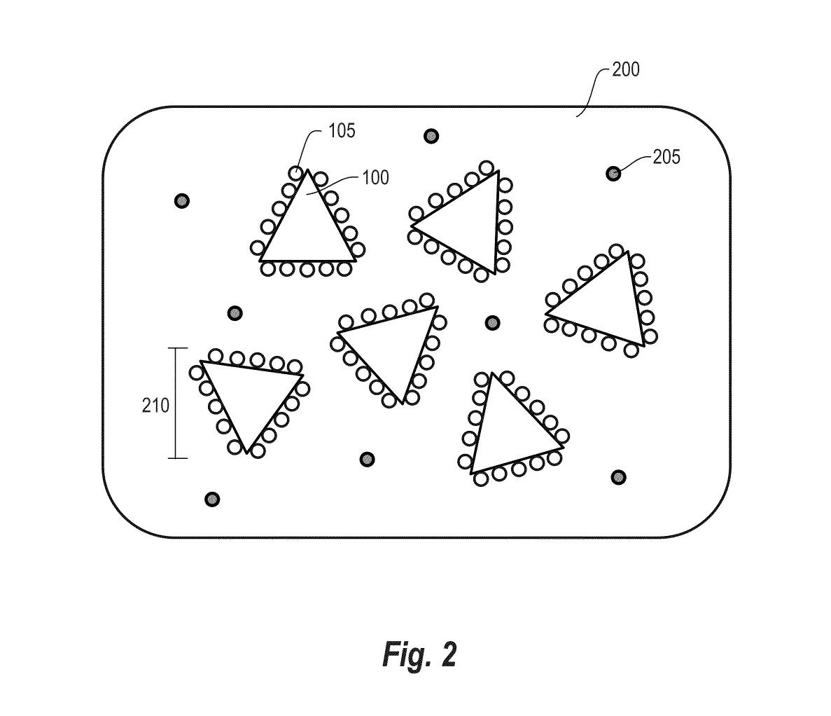

FIG. 1 is an example structure including metal-coated nanostructures 100 attached to a substrate 110, wherein each of the metal-coated nanostructures 100 includes one or more nanoparticles 105. As further discussed and depicted below in FIG. 2, the substrate 110 may be separated from the nanostructures 100 before such structures are used for molecular analysis.

In some examples, the nanostructures 100 may be fabricated on the substrate 110 using any suitable method. In one example, the first step of a suitable method may be to design the desired pattern of nanostructures 100 on a mold using methods such as e-beam lithography, photolithography, laser interference lithography, Focused Ion Beam (FIB) or self-assembly of spheres. Then, the pattern may be transferred onto the suitable substrate 110. In some examples, suitable polymer substrates may include polyimide, polycarbonate, polymethyl methacrylate (PMMA) or polydimethylsiloxane (PDMS). In other examples, other suitable substrates may include silicon dioxide. In yet other examples, any other substrate that can be used with the desired method of nanostructure fabrication may be used.

Next, in some examples, the nanostructures 100 may be fabricated using a number of different methods such as 3-D imprinting methods, embossing, chemical vapor deposition (CVD) growth, etching or roll-to-roll processes. In some examples, an array of nanostructure 100 may be fabricated on a substrate 110.

In some examples, the nanostructures 100 may be fabricated from one or more organic materials. In such examples, the nanostructures 100 may include one or more monomers, oligomers or polymers of thermoplastic or ultraviolet (UV) curable materials, such as photoresist, polycarbonate, PDMS, polymethyl methacrylate (PMMA), nanoimprint resist or a combination thereof. One nanostructure 100 may have the same or different composition of organic materials as another nanostructure 100 fabricated on the same substrate 110.

Alternatively, in other examples, the nanostructures 100 may be fabricated using one or more flexible inorganic materials. In some examples, suitable inorganic materials may include silicon oxide, silicon, silicon nitride, alumina, diamond, diamond-like carbon, aluminum, copper or other like materials. Similar to the nanostructures 100 including organic materials, each nanostructure 100 may have the same or different composition of inorganic materials as other nanostructures 100 fabricated on the same substrate 110.

In some examples, after fabrication, the height of the nanostructures 100 may range from about 10 nm to 10 micron, and the diameter may range from about 10 nm to 10 micron. In the examples wherein an array of nanostructures 100 is fabricated, one structure in the plurality of structures is the same height or a different height as a different structure in the plurality of structures.

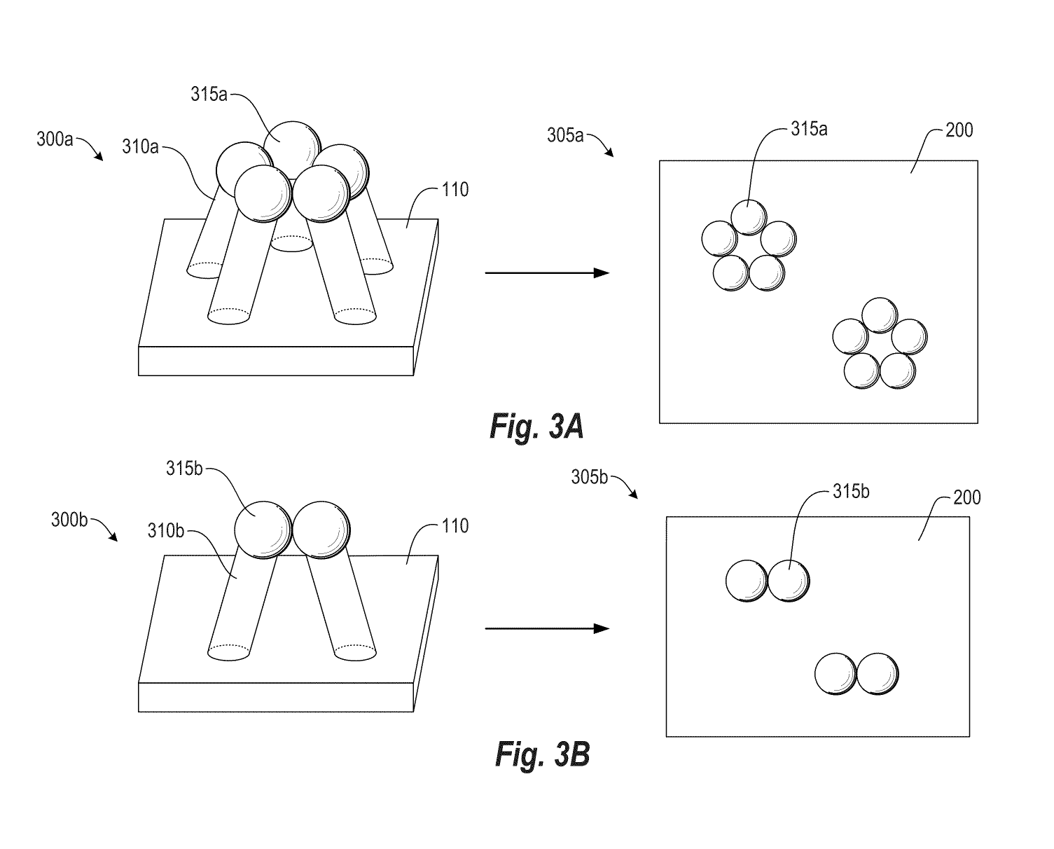

Additionally, the nanostructures may be in any shape. In one example, as seen in FIG. 1 and FIG. 2, the nanostructures may be in a nanocone shape. In another example, as seen below in FIG. 3, the nanostructures may be in a nanofinger shape. In yet other examples, the nanostructures may be in any other shape.

The metal coating on the nanostructures 100 may include one or more SERS active materials which support “intense” surface plasmons, such as noble metals or aluminum. As used herein, “intense” means that the magnitude of the surface electromagnetic field generated by incident light on the nanostructures 100 is at least one hundred times greater when the SERS-active material is present than when the SERS-active material is absent. In some examples, the nanostructures 100 may be coated with aluminum, gold, silver, copper, platinum or an alloy thereof. The metal may be coated over the entire nanostructure 100 or may be selectively coated over a part thereof. The nanostructure 100 may also be coated with multiple layers of metals and/or metal alloys. In one example, the nanostructure 100 may be coated with a 10 to 100 nm thick layer of silver metal with a 1 to 50 nm gold metal over-coating. In another example, the nanostructure 100 may be coated with a 10 to 100 nm thick layer of gold metal with a 1 to 50 nm silver metal over-coating. In yet other examples, the nanostructure 100 may be further coated with a thin dielectric layer, which may serve as a functional coat capable of selectively trapping and sensing analytes or other molecules.

After the metal-coated nanostructure 100 on the substrate 110 has been fabricated, the nanostructure 100 including one or more nanoparticles 105, as seen in FIG. 1, may be formed by exposing the nanostructure 100 to nanoparticles 105 dispersed in a dispersion medium.

In some examples, the nanoparticles 105 may include one or more metallic semiconducting materials and may have a diameter ranging from a few sub-nanometers to hundreds of nanometers. In some examples, the nanoparticles 105 may include aluminum, gold, silver, copper, platinum or an alloy thereof. In other examples, quantum dots that are 5 to 500 nm in diameter may be used. Some examples of quantum dots include cadmium selenide (CdSe), cadmium telluride (CdTe), cadmium sulfide (CdS), cadmium selenide sulfide (CdSeS), cadmium telluride sulfide (CdTeS), indium arsenide (InAs), indium phosphide (InP), zinc selenide (ZnSe), zinc sulfide (ZnS) or any combination thereof.

In some examples, the nanoparticles 105 may be further functionalized to allow for the specific binding of particular target molecules to the nanoparticles 105. In one example, the nanoparticle 105 may be further coated with a thin dielectric layer substantially similar to the thin dielectric layer that the nanostructure 100 may be coated with, in order to allow for such binding. In such an example, the target molecules may be analytes. Accordingly, in the example wherein the target molecules are analytes, the nanoparticles 105 may be capable of attracting the analytes from a dispersion to the surface of the nanostructures 100 for sensing.

The nanoparticles 105 may be dispersed in a dispersion medium before being exposed to the nanostructure 100. The dispersion medium used may vary depending on the composition of the nanoparticles 105. In some examples, the dispersion medium may be any inert medium, so long as the nanoparticles 105 may be dispersed in it. In one example, if the nanoparticles 105 are composed of gold, the dispersion medium used may be water or DMSO. In another example, gold nanoparticles 105 may be dispersed in alcohols. In yet another example, if the nanoparticles 105 are composed of quantum dots, the dispersion medium used may be water.

In some examples, analytes may be introduced to a nanostructure 100 including nanoparticles 105 having a functional coat. In some such examples, the analytes may attach anywhere on the nanostructure 100. In other examples, the analytes may attach on the nanoparticles 105 due to the surface plasmon effect, which tends to concentrate the analytes at the nanoparticles 105 under laser illumination. Additionally, if only portions of a nanostructure 100 are coated with SERS-active metal or metals, the analytes may also mainly be drawn to those coated portions.

FIG. 2 is a depiction of example nanostructures including nanoparticles 210 after being separated from the substrate in a medium 200 including analytes 205.

After fabrication of the nanostructures 100 including nanoparticles 105 on the substrate 110, the nanostructures 100 including nanoparticles 105 may be separated from the substrate. In some examples, this procedure is accomplished by immersing the nanostructures 210 in a solution and dissolving the substrate 110. Depending on the composition of the substrate 110, different solutions may be used. In one example, if the substrate 110 is comprised of a polymer, a solution including acetone may be used to dissolve the substrate 110. In another example, if the substrate 110 is comprised of silicon dioxide, a solution including hydrofluoric acid may be used to dissolve the substrate 110. In yet other example, if the substrate 110 is comprised of polymethyl methacrylate (PMMA), a solution including acetone may be used to dissolve the substrate 110. In other examples wherein the substrate 110 is comprised of different materials, different solutions may be used.

In other examples, the nanostructures 100 including nanoparticles 105 may be released from the substrate 110 by etching away the substrate or a part of the substrate. In some examples wherein etching is used, the substrate may be dry etched. In other examples, wet etching may be used. In one specific example wherein dry etching is used, reactive ion etching may be used. In reactive ion etching, the substrate may be “etched” away by ions. In such an example, the gas used to generate such ions may include, but is not limited to, argon, oxygen, CHF₃, CF₄, Ch₂, and HBr.

After the substrate 110 has been dissolved or etched away, the nanostructures including nanoparticles 210 may be used to detect analytes and target molecules 205. In addition to increasing the SERS signal of target molecules and other analytes 205, these structures 210 may have a better chance of capturing target molecules and analytes 205 in a medium 200 as they are free-standing. In such examples wherein substrate-free or free-standing nanostructures 210 are used, these structures may diffuse through the medium 200 to find target molecules or analytes 205. Because these nanostructures 210 are not attached to a substrate and are free floating, they may be able to find target molecules or analytes 205 more easily given the flexible path these structures 210 are able to travel.

FIG. 3 is a depiction of example nanostructures 310a, 310b including nanoparticles 315a, 315b attached to a substrate 110 and separated from the substrate 110. As discussed previously, the nanostructures 310a, 310b may have a variety of shapes. In such examples wherein a nanocone shape is not used, the materials comprising the nanostructures 310a, 310b and the nanoparticles 315a, 315b, and the mechanisms and materials involved in the creation of the structures and the release of the nanostructures 310a, 310b from the substrate 110 may be substantially the same as when the nanocone shape is used.

In some examples, as depicted in FIG. 3, the nanostructures 310a, 310b may be nanofinger shaped. In one example, the plurality of nanostructures 310a, 310b, including substantially the same materials as discussed above, may be bent at their tips such that a teepee-like shape is formed. As seen in FIG. 3, in one example, five nanofinger shaped nanostructures 310a may be bent at their tips; in another example, two nanofinger shaped nanostructures 310b may be bent at their tips.

As noted above, the method by which these nanostructures 310a, 310b can be formed may be substantially the same as the method for forming nanostructures as discussed above in FIG. 1 and FIG. 2. After the nanofinger shaped nanostructures 310a, 310b are exposed to the nanoparticles 315a, 315b dispersed in medium, removal of the medium and drying of the nanostructures 310a, 310b including the nanoparticles 315a, 315b may trigger a self-closing process, wherein the nanostructures 310a, 310b including the nanoparticles 315a, 315b bend toward each other to form the teepee shape. During self-closing, micro-capillary forces may cause the nanostructures 310a, 310b and nanoparticles 315a, 315b to bend towards each other at an angle, forming a teepee-like structure at the tips 115 such that adjacent nanoparticles 315a, 315b are only separated by a small gap of 0.5 to 1 nm. In other examples, methods such as e-beam, ion-beam, the electric charge effect, magnetic force or the mechanic agitation effect may be used to induce self-closing as well. In some examples, the teepee form of these structures may be permanent and may rely on Van der Waals interactions in order to hold them together.

Again, as discussed above, the substrate 110 on which the nanofinger shaped nanostructures 310a, 310b including nanoparticles 315a, 315b are attached may be separated in substantially the same manner as described above in FIG. 1 and FIG. 2. In some examples, after the nanofinger-shaped nanostructures 310a, 310b including the nanoparticles 315a, 315b are removed from the substrate 110, the structures may be exposed to a medium 200 that may include analytes or other target molecules (not pictured). In some examples, the nanoparticles 315a, 315b may become detached from the nanofinger shaped nanostructures 310a, 310b as illustrated in depiction 305a and 305b. In other examples, the nanoparticles 315a, 315b may remain attached to the nanofinger shaped nanostructures 310a, 310b. In both examples, the structures may bind to target molecules or analytes as disclosed herein.

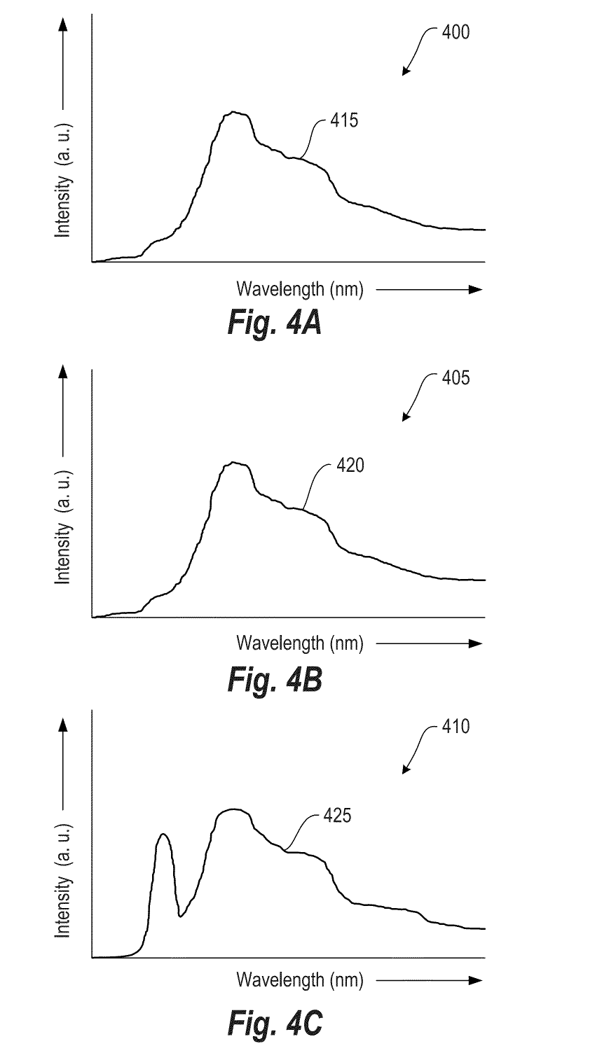

FIGS. 4A-4C, on coordinates of intensity (arbitrary units or a.u.) and wavelength (nm), are representative optical scattering spectra depicting the plasmonic resonance from, respectively, an array of nanostructures 300, an array of nanostructures including analytes 305, and an array of nanostructures including a target-linked nanoparticle and analytes 310, all as described herein.

As seen in FIGS. 4A and 4B, a representative optical scattering spectrum of an array of nanostructures 415 and a representative optical scattering spectrum of an array of nanostructures with analytes 420 appear very similar. There is virtually no difference between the two plasmonic resonance curves 415, 420. Accordingly, it appears that the presence of analytes in the nanostructure is undetectable using optical scattering if the nanostructure is not a nanostructure including a nanoparticle. On the other hand, as seen in FIG. 4C, a representative optical scattering spectrum of an array of nanostructures including a target-linked nanoparticle and analytes 425, the presence of a target-linked nanoparticle will alter the plasmonic resonance curve by creating an additional peak. Because target-linked nanoparticles may bind with analytes, as discussed above, using optical scattering spectra to determine the presence of those nanoparticles can indirectly determine the presence of analytes.

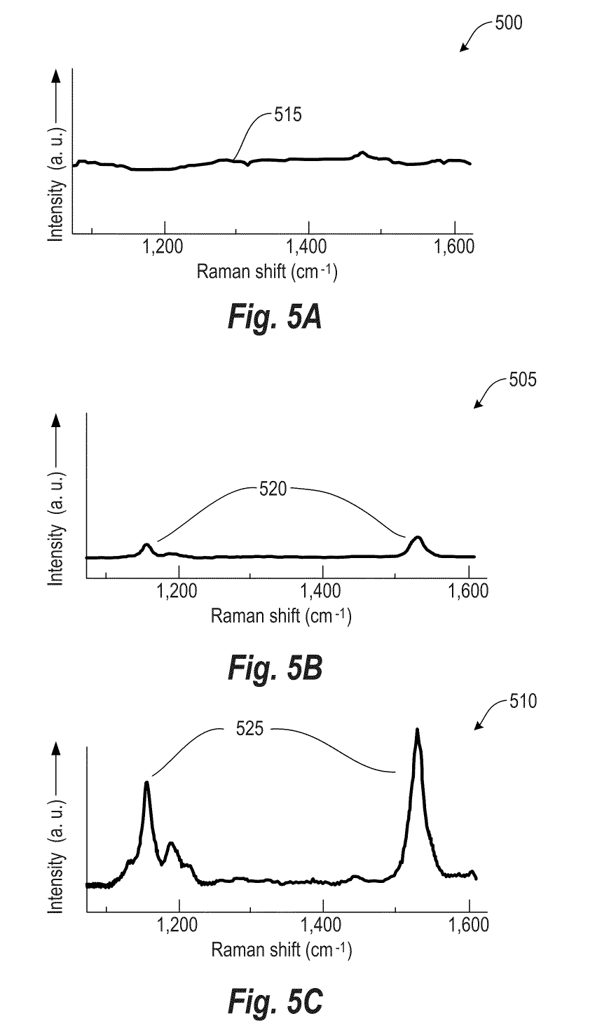

FIGS. 5A-5C, on coordinates of intensity in arbitrary units (a.u.) and Raman shift (cm⁻¹), are representative Raman spectra depicting the intensity of signals from, respectively, an array of nanostructures 500, an array of nanostructures including analytes 505, and an array of nanostructures including a target-linked nanoparticle and analytes 510, all as described herein.

As can be seen from comparing FIGS. 5A and 5B, representative Raman spectra of an array of nanostructures 515 and an array of nanostructures including analytes 520, the analytes will cause two small resonance peaks in the Raman spectra. As can be seen from FIG. 5C, the representative Raman spectrum for an array of nanostructures including a target-linked nanoparticle and analytes 525, the presence of a target-linked nanoparticle greatly amplifies the intensity of the signal that the analytes give off. In other words, the resonance peaks of the analytes from nanostructures without a target-linked nanoparticle are much smaller than the resonance peaks of the analytes from nanostructures with a target-linked nanoparticle. In one example, in sensing applications, having amplified resonance peaks may allow for easier and more accurate detection of analytes and other molecules bonded to a nanostructure.

What is claimed is:

1. A structure including:
a nanostructure and a nanoparticle attached to the nanostructure, wherein the nanostructure is free-standing and wherein the nanoparticle, the nanostructure or both the nanoparticle and the nanostructure are coated with a metal coating; or
a plurality of nanoparticles, wherein the plurality of nanoparticles is free-standing and wherein each nanoparticle in the plurality is coated with a metal coating and is separated from one other nanoparticle or two other nanoparticles by a distance of 0.5 nm to 1 nm.

2. The structure of claim 1 wherein the nanostructure includes an organic material selected from the group consisting of thermoplastic polymers, UV curable materials, and a combination thereof.

3. The structure of claim 1 wherein the nanostructure includes an inorganic material selected from the group consisting of alumina, aluminum, copper, diamond, diamond-like carbon, germanium, silicon, silicon nitride, silicon oxide, and silicon oxynitride.

4. The structure of claim 1 wherein the metal coating includes a material that supports surface plasmons.

5. The structure of claim 1 wherein the nanostructure is 10 nm to 10 micron in height and in diameter.

6. The structure of claim 1 wherein the nanoparticle includes a semiconducting material.

7. The structure of claim 6 wherein the nanoparticle is selected from the group consisting of aluminum, gold, silver, copper, platinum, cadmium selenide, cadmium telluride, cadmium sulfide, cadmium selenide sulfide, cadmium telluride sulfide, indium arsenide, indium phosphide, zinc selenide, zinc sulfide, and a combination thereof.

8. A plurality of structures for molecular analysis, wherein each structure includes:
a nanostructure and a nanoparticle attached to the nanostructure, wherein the nanostructure is free-standing and wherein the nanoparticle, the nanostructure or both the nanoparticle and the nanostructure are coated with a metal coating; or
a plurality of nanoparticles, wherein the plurality of nanoparticles is free-standing and wherein each nanoparticle in the plurality is coated with a metal coating and is separated from one other nanoparticle or two other nanoparticles by a distance of 0.5 nm to 1 nm.

9. The plurality of structures of claim 8 wherein the nanostructure is 10 nm to 10 micron in height and in diameter; wherein one nanostructure in the plurality of structures is the same height or is a different height than a different structure in the plurality of structures; and wherein the nanostructure includes a material selected from the group consisting of thermoplastic polymers, UV curable materials, and a combination thereof or includes an inorganic material selected from the group consisting of alumina, aluminum, copper, diamond, diamond-like carbon, germanium, silicon, silicon nitride, silicon oxide, and silicon oxynitride.

10. The plurality of structures of claim 8 wherein the metal coating includes a material that supports surface plasmons; and wherein the nanoparticle includes a semiconducting material.

11. The plurality of structures of claim 8 wherein one structure in the plurality of structures is of the same composition or of a different composition as a different structure in the plurality of structures.

12. The plurality of structures of claim 8, wherein molecular analysis is conducted using SERS analysis, enhanced fluorescence, enhanced luminescence, optical scattering, optical absorption or plasmonic sensing.

13. The plurality of structures of claim 12, wherein molecular analysis is conducted using SERS analysis, and the SERS apparatus includes a Raman-excitation light source and a photodetector, wherein the plurality of structures is between the photodetector and the light source.

14. A method for preparing a structure for molecular analysis, the method including:
forming a nanostructure on a substrate;
providing a nanoparticle;
providing the nanostructure, the nanoparticle or both the nanostructure and nanoparticle with a metal coating;
exposing the nanostructure to the nanoparticle in a medium;
removing the medium; and
separating the substrate from the nanostructure.

15. The method of claim 14 further including forming an array of nanostructures on the substrate.

16. The method of claim 14 further including separating the nanostructure from the nanoparticle.

17. The method of claim 14 wherein the nanostructure includes an organic material selected from the group consisting of thermoplastic polymers, UV curable materials and a combination thereof or includes an inorganic material selected from the group consisting of alumina, aluminum, copper, diamond, diamond-like carbon, germanium, silicon, silicon nitride, silicon oxide, and silicon oxynitride.

18. The method of claim 14 wherein the metal coating includes a material that supports surface plasmons.

19. The method of claim 14 wherein the nanoparticles include a semiconducting material.

20. The method of claim 14 wherein the step of separating the substrate from the nanostructure includes dissolving the substrate or a part of the substrate, or etching the substrate or a part of the substrate.
